(19) United States
(12) Patent Application Publication
(10) Pub. No.: US 2023/0412019 A1
(43) Pub. Date: Dec. 21, 2023

(54) ROTATING ELECTRIC MACHINE AND DRIVE DEVICE

(71) Applicant: Nidec Corporation, Kyoto (JP)

(72) Inventors: Yusuke MAKINO, Kyoto (JP); Satoshi KAJIKAWA, Kyoto (JP); Ippei YAMASAKI, Kyoto (JP)

(21) Appl. No.: 18/037,695

(22) PCT Filed: Jun. 11, 2021
(86) PCT No.: PCT/JP2021/022341

§ 371 Date: May 18, 2023

(30) Foreign Application Priority Data
Nov. 19, 2020 (JP) 2020-192815

(51) Int. Cl. H02K 1/276; H02K 1/32; H02K 9/19

(52) U.S. Cl. CPC H02K 1/276; H02K 1/32; H02K 9/19; H02K 29/03

(57) ABSTRACT

A rotating electric machine includes a rotor rotatable about a central axis, and a stator positioned radially outside the rotor. The rotor includes a shaft axially extending about the central axis, rotor core portions fixed to an outer peripheral surface of the shaft and in an axial direction, a magnet held by each of the rotor core portions, and at least one spacer that is a non-magnetic body with a ring-plate shape about the central axis and is between the rotor core portions which are axially adjacent to each other. The spacer is smaller in outer diameter than the rotor core portion.

### CROSS-REFERENCE TO RELATED APPLICATIONS

This is a U.S. national stage of application No. PCT/JP2021/022341, filed on Jun. 11, 2021, with priority under 35 U.S.C. § 119(a) and 35 U.S.C. § 365(b) being claimed from Japanese Patent Application No. 2020-192815, filed on Nov. 19, 2020, the entire disclosures of which are hereby incorporated herein by reference.

### 1. FIELD OF THE INVENTION

The present disclosure relates to a rotating electric machine and a drive device.

### 2. BACKGROUND

A rotating electric machine includes a rotor rotatable about a central axis, and a stator positioned radially outside the rotor. The rotor includes a plurality of rotor core portions arranged in an axial direction. Conventionally, cogging torque is reduced and vibration of a motor is suppressed by providing a step skew by shifting the circumferential position of each rotor core portion.

By providing a gap between rotor core portions axially adjacent to each other, an advantageous effect in terms of magnetic characteristics such as suppressing leakage magnetic flux may be obtained. However, when a spacer is simply interposed between the rotor core portions in order to provide the gap, an eddy current loss increases and the rotation efficiency may decrease.

### SUMMARY

An example embodiment of the present disclosure includes a rotor rotatable about a central axis, and a stator positioned radially outside the rotor. The rotor includes a shaft axially extending about the central axis, rotor core portions fixed to an outer peripheral surface of the shaft and extending in an axial direction, a magnet held by each of the rotor core portions, and at least one spacer including a non-magnetic body with a ring-plate shape about the central axis and is between the rotor core portions axially adjacent to each other. The spacer is smaller in outer diameter than the rotor core portion.

One example embodiment of the present disclosure is a drive device that is mounted in a vehicle and rotates an axle, the drive device including the rotating electric machine described above, a transmission that is connected to the rotating electric machine to transmit rotation of the rotor to the axle, a housing that accommodates the rotating electric machine and the transmission device, and a refrigerant flow path that is provided in the housing to allow a refrigerant to flow. The refrigerant flow path includes a stator refrigerant supply portion to supply a refrigerant to the stator, a shaft flow path portion in the shaft, and a connection flow path portion that connects a downstream side portion of the stator refrigerant supply portion and an upstream side portion of the shaft flow path portion.

One preferred embodiment of the present disclosure is a drive device that is mounted in a vehicle and rotates an axle, the drive device including the rotating electric machine described above, a transmission that is connected to the rotating electric machine to transmit rotation of the rotor to the axle, a housing that accommodates the rotating electric machine and the transmission device, and a refrigerant flow path that is provided in the housing to permit a refrigerant to flow therethrough. The refrigerant flow path includes a stator refrigerant supply portion to supply a refrigerant to the stator, a shaft flow path portion in the shaft, and a supply flow path portion to supply a refrigerant to an upstream side portion of the stator refrigerant supply portion and an upstream side portion of the shaft flow path portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an outline configuration diagram schematically illustrating a drive device of one example embodiment of the present disclosure.

FIG. 2 is a perspective view illustrating a rotor of a rotating electric machine according to an example embodiment of the present disclosure.

FIG. 3 is a longitudinal sectional view illustrating the rotor.

FIG. 4 is a transverse sectional view illustrating a IV-IV cross-section of FIG. 3.

FIG. 5 is an outline configuration diagram schematically illustrating a drive device of a modification of an example embodiment of the present disclosure.

FIG. 6 is a transverse sectional view illustrating a rotor of a modification of an example embodiment of the present disclosure.

### DETAILED DESCRIPTION

The following description will be made with a vertical direction being defined on the basis of the positional relationship in a case where the drive devices of the example embodiments are mounted in vehicles positioned on a horizontal road surface. That is, it is sufficient that the relative positional relationship regarding the vertical direction described in the following example embodiments is satisfied at least in the case where the drive device is mounted in a vehicle positioned on a horizontal road surface.

The drawings illustrate an XYZ coordinate system appropriately as a three-dimensional orthogonal coordinate system. In the XYZ coordinate system, a Z axis direction is the vertical direction. A+Z side is an upward vertical direction, and a −Z side is a downward vertical direction. In the following description, the upward vertical direction and the downward vertical direction will be referred to simply as the “upper side” and the “lower side”, respectively. An X axis direction is a direction orthogonal to the Z axis direction and is a front-rear direction of the vehicle mounted with the drive device. In the following example embodiments, a +X side is a front side of the vehicle, and a −X side is a rear side of the vehicle. A Y axis direction is a direction orthogonal to both the X axis direction and the Z axis direction, and is a left-right direction of the vehicle, i.e., a vehicle width direction. In the following example embodiments, a +Y side is a left side of the vehicle, and a −Y side is a right side of the vehicle. The front-rear direction and the left-right direction are each a horizontal direction orthogonal to the vertical direction.

Note that the positional relationship in the front-rear direction is not limited to the positional relationship in the following example embodiments, and the +X side may be the rear side of the vehicle and the −X side may be the front side of the vehicle. In this case, the +Y side is the right side of the vehicle, and the −Y side is the left side of the vehicle. In the present description, a “parallel direction” includes a substantially parallel direction, and an “orthogonal direction” includes a substantially orthogonal direction.

A central axis J illustrated in the drawings as appropriate is a virtual axis extending in a direction intersecting the vertical direction. More specifically, the central axis J extends in the Y axis direction orthogonal to the vertical direction, i.e., the left-right direction of the vehicle. In the following description, unless otherwise stated, a direction parallel to the central axis J is simply called “axial direction”, a radial direction about the central axis J is simply called “radial direction”, and a circumferential direction about the central axis J, i.e., a direction about the central axis J is simply called “circumferential direction”. In the present example embodiment, a first axial side corresponds to the right side (−Y side), and a second axial side corresponds to the left side (+−Y side).

An arrow θ appropriately illustrated in the drawings indicates the circumferential direction. In the following description, a clockwise side about the central axis J as viewed from the right side in the circumferential direction, i.e., a side (+θ side) to which the arrow θ faces is called “first circumferential side”, and a counterclockwise side about the central axis J as viewed from the right side in the circumferential direction, i.e., a side (−θ side) opposite to the side to which the arrow θ faces is called “second circumferential side”.

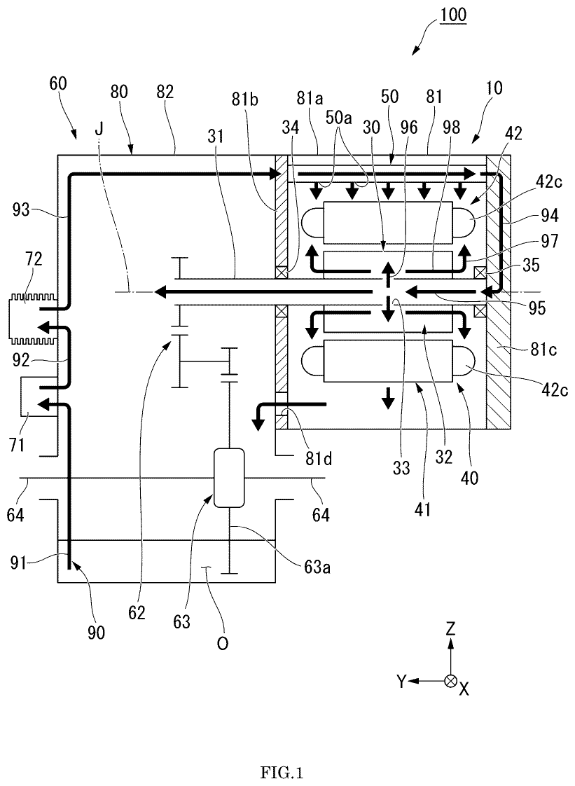

A drive device 100 of the present example embodiment illustrated in FIG. 1 is a drive device that is mounted in a vehicle and rotates an axle 64. The vehicle mounted with the drive device 100 is a vehicle with a motor as a power source, such as a hybrid vehicle (HEV), a plug-in hybrid vehicle (PHV), and an electric vehicle (EV). As illustrated in FIG. 1, the drive device 100 includes a rotating electric machine 10, a housing 80, a transmission device 60, and a refrigerant flow path 90. The rotating electric machine 10 includes a rotor 30 rotatable about the central axis J, and a stator 40 positioned radially outside the rotor 30. Configurations of the rotating electric machine 10 other than the above will be described later.

The housing 80 accommodates the rotating electric machine 10 and the transmission device 60. The housing 80 includes a motor housing 81, and a gear housing 82. The motor housing 81 is a housing that internally accommodates the rotor 30 and the stator 40. The motor housing 81 is connected to the right side of the gear housing 82. The motor housing 81 has a peripheral wall portion 81a, a partition wall portion 81b, and a lid portion 81c. The peripheral wall portion 81a and the partition wall portion 81b are each a part of an identical single member, for example. The lid portion 81c is separate from, for example, the peripheral wall portion 81a and the partition wall portion 81b.

The peripheral wall portion 81a has a tubular shape surrounding the central axis J and opening on the right side. The partition wall portion 81b is connected to an end portion of the left side of the peripheral wall portion 81a. The partition wall portion 81b axially separates an inside of the motor housing 81 and an inside of the gear housing 82. The partition wall portion 81b has a partition wall opening 81d that connects the inside of the motor housing 81 and the inside of the gear housing 82. The partition wall portion 81b holds a bearing 34. The lid portion 81c is fixed to an end portion of the right side of the peripheral wall portion 81a. The lid portion 81c closes an opening on the right side of the peripheral wall portion 81a. The lid portion 81c holds a bearing 35.

The gear housing 82 accommodates therein a decelerator 62 and a differential 63, which will be described later, of the transmission device 60, and an oil O. The oil O is stored in a lower region in the gear housing 82. The oil O circulates in the refrigerant flow path 90 described later. The oil O is used as a refrigerant for cooling the rotating electric machine 10. The oil O is used as lubricating oil for the decelerator 62 and the differential 63. As the oil O, for example, in order to achieve a function as a refrigerant and a lubricating oil, it is preferable to use an oil equivalent to an automatic transmission fluid (ATF) having a relatively low viscosity.

The transmission device 60 is connected to the rotating electric machine 10 and transmits the rotation of the rotor 30 to the axle 64 of the vehicle. The transmission device 60 of the present example embodiment includes the decelerator 62 connected to the rotating electric machine 10, and the differential 63 connected to the decelerator 62. The differential 63 includes a ring gear 63a. To the ring gear 63a, torque output from the rotating electric machine 10 is transmitted via the decelerator 62. An end portion of the lower side of the ring gear 63a is immersed in the oil O stored in the gear housing 82. When the ring gear 63a rotates, the oil O is stirred up. The oil O having been stirred up is supplied as a lubricating oil to, for example, the decelerator 62 and the differential 63.

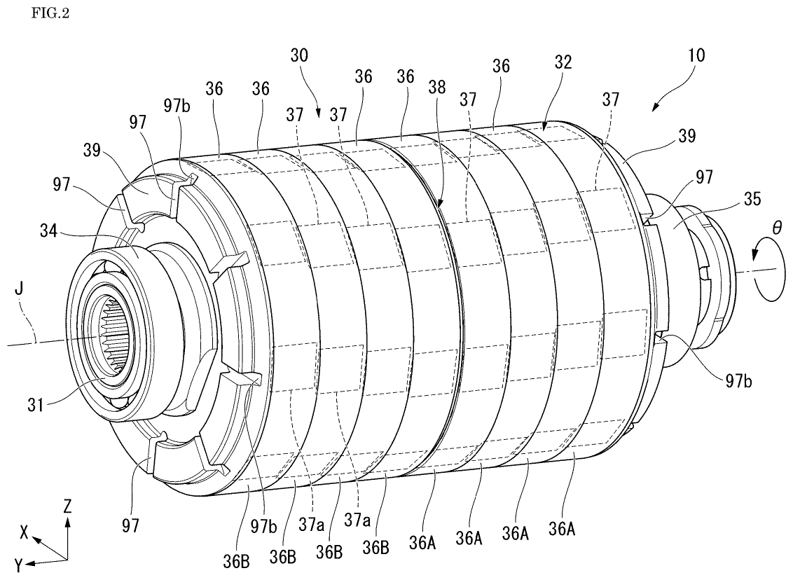

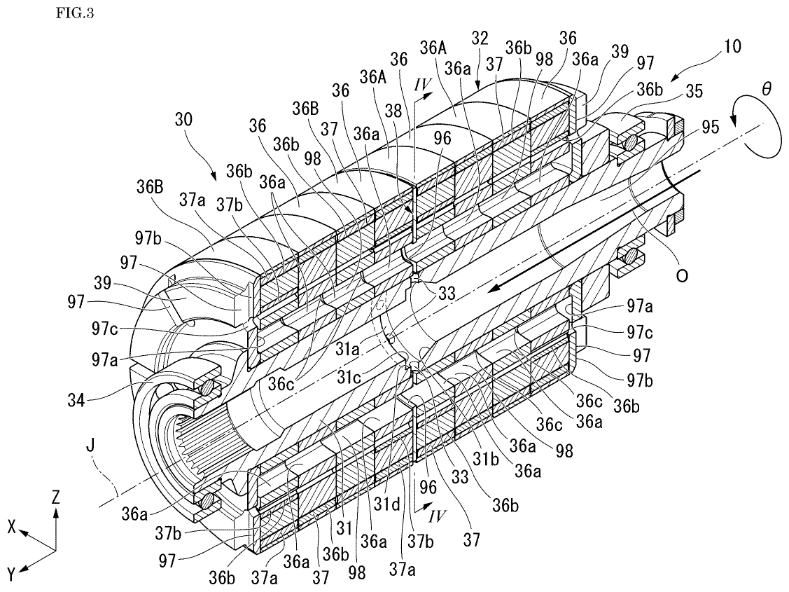

The rotating electric machine 10 is a portion that drives the drive device 100. The rotating electric machine 10 is positioned on the right side of the transmission device 60, for example. In the present example embodiment, the rotating electric machine 10 is a motor. The torque of the rotor 30 of the rotating electric machine 10 is transmitted to the transmission device 60. The rotor 30 includes a shaft 31 axially extending about the central axis J, and a rotor body 32 fixed to the shaft 31. As illustrated in FIGS. 2 and 3, the rotor body 32 includes a plurality of rotor core portions 36 fixed to the outer peripheral surface of the shaft 31 and arranged in the axial direction, a magnet 37 held by each of the rotor core portions 36, at least one spacer 38 arranged between the rotor core portions 36 axially adjacent to each other, and an end plate 39 arranged at an axial end portion of the rotor body 32. That is, the rotor 30 includes the plurality of rotor core portions 36, the plurality of magnets 37, the spacer 38, and the end plate 39.

As illustrated in FIG. 1, the shaft 31 is rotatable about the central axis J. The shaft 31 is rotatably supported by the bearings 34 and 35. In the present example embodiment, the shaft 31 is a hollow shaft. The shaft 31 has a tubular shape through which the oil O as a refrigerant can circulate inside thereof. The shaft 31 extends across the inside of the motor housing 81 and the inside of the gear housing 82. An end portion of the left side of the shaft 31 protrudes inside the gear housing 82. The decelerator 62 is connected to the end portion of the left side of the shaft 31.

As illustrated in FIG. 3, the shaft 31 has a substantially cylindrical shape. The shaft 31 has an inner diameter of an end portion on the first axial side (−Y side) that is smaller than an inner diameter of a part other than the end portion of the first axial side. The shaft 31 has a part whose inner diameter increases gradually or stepwise from the end portion of the first axial side as approaching the second axial side (+Y side). This part corresponds to an upstream side portion of a shaft flow path portion 95 of the refrigerant flow path 90 described later. The shaft 31 has a refrigerant guide portion 31a recessed radially outward from an inner peripheral surface of the shaft 31, and a refrigerant supply hole 33 penetrating a peripheral wall of the shaft 31.

The refrigerant guide portion 31a is an annular groove about the central axis J. The refrigerant guide portion 31a includes a pair of groove walls 31b and 31c arranged axially apart from each other, and a groove bottom 31d positioned axially between the pair of first and second groove walls 31b and 31c and facing the radial inside. Of the pair of groove walls 31b and 31c, the first groove wall 31b positioned on the first axial side has a tapered shape positioned radially outward as approaching the second axial side. Therefore, the oil O flowing in the shaft 31 from the first axial side to the second axial side is stably guided to the groove bottom 31d by the first groove wall 31b. Of the pair of groove walls 31b and 31c, the second groove wall 31c positioned on the second axial side has a planar shape expanding in a direction perpendicular to the central axis J and faces the first axial side. Therefore, the oil O guided to the groove bottom 31d is suppressed from going over the second groove wall 31c in the second axial side, and the oil O is stably held by the refrigerant guide portion 31a. The groove bottom 31d is positioned on the radially outermost side in the refrigerant guide portion 31a.

The refrigerant supply hole 33 has a circular hole shape radially extending inside the peripheral wall of the shaft 31. A plurality of the refrigerant supply holes 33 are provided in the shaft 31. The plurality of refrigerant supply holes 33 are arranged at intervals in the circumferential direction from one another. In the present example embodiment, eight refrigerant supply holes 33 are provided at equal pitches in the circumferential direction. The refrigerant supply hole 33 is opening in the groove bottom 31d. That is, the refrigerant supply hole 33 is opening in the refrigerant guide portion 31a. According to the present example embodiment, the oil O flowing in the shaft 31 is efficiently guided to the refrigerant supply hole 33 by the refrigerant guide portion 31a, and flows in the rotor 30 as described later, whereby the cooling efficiency of the rotor 30 is enhanced.

The rotor core portion 36 is a magnetic body. As illustrated in FIGS. 2 and 3, the rotor core portion 36 has a tubular shape about the central axis J, and has a cylindrical shape in the present example embodiment. An inner peripheral surface of the rotor core portion 36 is fixed to the outer peripheral surface of the shaft 31 by press fitting or the like. The rotor core portion 36 and the shaft 31 are fixed to be relatively immovable in the axial direction, the radial direction, and the circumferential direction. The rotor core portion 36 includes a plurality of electromagnetic steel sheets (not illustrated) arranged to overlap each other in the axial direction.

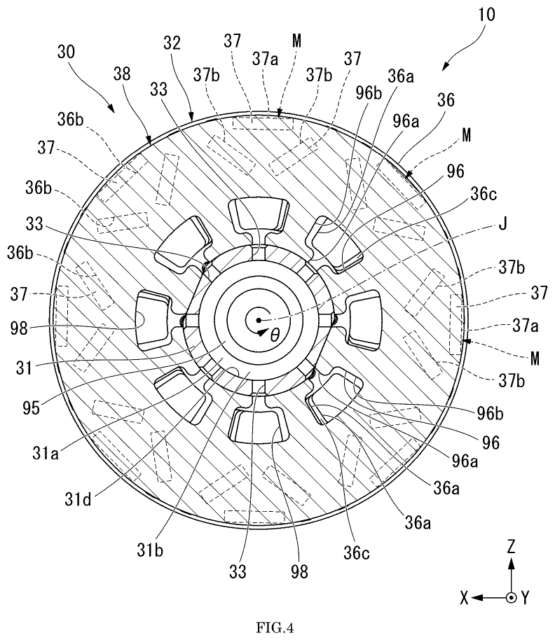

The rotor core portion 36 has a through hole 36a and a magnet accommodation hole 36b. The through hole 36a axially penetrates the rotor core portion 36. As illustrated in FIG. 4, the through hole 36a has a substantially quadrangular shape when viewed from the axial direction, and has a substantially rectangular shape extending in the circumferential direction in the present example embodiment. In short, the circumferential dimension of the through hole 36a is greater than the radial dimension of the through hole 36a. The circumferential dimension of the through hole 36a increases as approaching the radial outside. The radial dimension of the through hole 36a is substantially constant along the circumferential direction. A plurality of the through holes 36a are provided in the rotor core portion 36 at intervals from one another in the circumferential direction. In the present example embodiment, each of the rotor core portions 36 is provided with eight through holes 36a at equal pitches in the circumferential direction.

The magnet accommodation hole 36b axially penetrates the rotor core portion 36. The magnet accommodation hole 36b has a substantially quadrangular shape when viewed from the axial direction, and has a substantially rectangular shape in the present example embodiment. A plurality of the magnet accommodation holes 36b are provided in the rotor core portion 36. The plurality of magnet accommodation holes 36b have a set of three magnet accommodation holes 36b laid out in an isosceles triangle shape when viewed from the axial direction. A plurality of sets of the three magnet accommodation holes 36b are provided in the rotor core portion 36 at intervals from one another in the circumferential direction. In the present example embodiment, each of the rotor core portions 36 is provided with eight sets of three magnet accommodation holes 36b at equal pitches in the circumferential direction. The sets of three magnet accommodation holes 36b are arranged radially outside relative to the through hole 36a. The sets of three magnet accommodation holes 36b overlap the through hole 36a when viewed from the radial direction.

As illustrated in FIG. 2, in the present example embodiment, a gap is provided between a pair of the rotor core portions 36, of the plurality of rotor core portions 36, adjacent to each other with the spacer 38 interposed therebetween in the axial direction, by the spacer 38 interposed therebetween. No gap is provided between the rotor core portions 36 other than between the pair of rotor core portions 36 of the plurality of rotor core portions 36. A gap may be provided also between the rotor core portions 36 other than between the pair of rotor core portions 36. At least two or more of the plurality of rotor core portions 36 are arranged with their circumferential positions shifted from each other. That is, in the present example embodiment, since the rotor 30 is provided with a step skew, cogging torque and torque ripple can be reduced, vibration of the rotating electric machine 10 is suppressed, and the rotation efficiency is enhanced.

The plurality of rotor core portions 36 include a plurality of first rotor core portions 36A arranged on the first axial side (−Y side) relative to the spacer 38 and a plurality of second rotor core portions 36B arranged on the second axial side (+Y side) relative to the spacer 38. The plurality of first rotor core portions 36A are arranged to be shifted to the first circumferential side (+θ side) as separating from the spacer 38 to the first axial side. The plurality of second rotor core portions 36B are arranged to be shifted to the first circumferential side as separating from the spacer 38 to the second axial side. That is, in the present example embodiment, the orientation of the twist of the step skew of the plurality of first rotor core portions 36A arrayed on the first axial side of the spacer 38 and the orientation of the twist of the step skew of the plurality of second rotor core portions 36B arrayed on the second axial side of the spacer 38 are different from each other. This makes it possible to obtain effects such as further reduction of cogging torque and torque ripple. In the present example embodiment, three or more first rotor core portions 36A and three or more second rotor core portions 36B are provided, specifically, four first rotor core portions and four second rotor core portions are provided.

The magnet 37 is, for example, a neodymium magnet, a ferrite magnet, or the like. The magnet 37 has, for example, a rectangular plate shape. As illustrated in FIG. 4, a plurality of the magnets 37 are provided in the rotor core portion 36. The magnets 37 are accommodated in the respective magnet accommodation holes 36b. The magnets 37 are fixed to the rotor core portion 36 by, for example, a resin magnet holder not illustrated or the like. The plurality of magnets 37 have a set M of three magnets 37 laid out in an isosceles triangle shape when viewed from the axial direction. A plurality of sets M of the three magnets 37 are provided in the rotor core portion 36 at intervals from one another in the circumferential direction. In the present example embodiment, each of the rotor core portions 36 is provided with eight sets M of three magnets 37 at equal pitches in the circumferential direction. The sets M of the three magnets 37 are arranged radially outside relative to the through hole 36a. The sets M of the three magnets 37 overlap the through hole 36a when viewed from the radial direction.

The sets M of the three magnets 37 include a first magnet 37a and a pair of second magnets 37b. The first magnet 37a and the pair of second magnets 37b constitute a pole. The first magnet 37a is arranged in a part corresponding to the base in the set M having an isosceles triangle shape when viewed from the axial direction. The first magnet 37a is arranged at a radially outer end portion of the set M and extends in the circumferential direction. The pair of second magnets 37b are arranged in a part corresponding to two sides (isosceles) other than the base in the set M having an isosceles triangle shape when viewed from the axial direction. The pair of second magnets 37b are arranged radially inside the first magnet 37a. One of the pair of second magnets 37b is positioned radially inside as approaching the first circumferential side (+θ side), and the other is positioned radially outside as approaching the first circumferential side.

As illustrated in FIGS. 3 and 4, the spacer 38 is a non-magnetic body having a ring plate shape about the central axis J, and has an annular plate shape in the present example embodiment. The axial dimension, that is, the plate thickness dimension of the spacer 38 is greater than the plate thickness dimension of each of the plurality of electromagnetic steel sheets included in the rotor core portion 36. The spacer 38 of the present example embodiment is made of metal. Therefore, the mechanical strength and durability of the spacer 38 are high, and the axial dimension (plate thickness dimension) of the spacer 38 is accurately secured. This stabilizes the accuracy of the axial dimension of the rotor body 32, and stabilizes the performance of the rotating electric machine 10.

In the present example embodiment, one spacer 38 is provided in the rotor 30. The spacer 38 is arranged at an axial center part of the rotor body 32. The spacer 38 is smaller in outer diameter than the rotor core portion 36. According to the present example embodiment, by providing the spacer 38 between the rotor core portions 36 axially adjacent to each other, an advantageous effect in terms of magnetic characteristics such as suppressing leakage magnetic flux can be obtained, and the outer diameter of the spacer 38 is smaller than the outer diameter of the rotor core portion 36, and therefore an occurrence of an eddy current loss in an outer peripheral portion of the rotor 30 can be suppressed, and the rotation efficiency can be enhanced.

The spacer 38 has a spacer flow path portion 96. The spacer flow path portion 96 has a recessed shape recessed radially outward from an inner peripheral surface of the spacer 38. The spacer flow path portion 96 is opening on the inner peripheral surface of the spacer 38 and is not opening on an outer peripheral surface. The spacer flow path portion 96 connects the refrigerant supply hole 33 and the through hole 36a. According to the present example embodiment, the oil O flowing in the shaft 31 is supplied from the refrigerant supply hole 33 to the through hole 36a of the rotor core portion 36 through the spacer flow path portion 96 by centrifugal force or the like. The rotor 30 is cooled by the oil O flowing through the through hole 36a. Since the temperature rise of the rotor 30 can be suppressed, a range of selection of members constituting the rotor 30 is widened, for example, an inexpensive magnet 37 in which the upper limit value of the operating temperature is not too high can be used. Unlike the electromagnetic steel sheet or the like constituting the rotor core portion 36, for example, in the spacer 38 of the present example embodiment, it is possible to arbitrarily change the thickness dimension and the shape of the spacer flow path portion 96 and it is easy to change the design, that is, the degree of freedom of the shape is high, and therefore it is possible to easily respond to various demands for the rotating electric machine 10.

In the present example embodiment, as described above, since the rotor 30 is provided with the step skew, a part 36c of an end surface facing the axial direction of the rotor core portion 36 opposes the through hole 36a of the other rotor core portion 36 axially adjacent to this rotor core portion 36, and the part 36c of the end surface constitutes a part of an inner surface of an oil flow path (a through hole flow path portion 98 described later) in the rotor 30. In short, since the surface area of the flow path in the rotor 30 is increased by applying the step skew, the cooling efficiency by the oil O is further enhanced.

The spacer flow path portion 96 axially penetrates the spacer 38. In this case, while the spacer 38 has a simple configuration, the oil O can be supplied from the spacer flow path portion 96 to each of the through hole 36a of the rotor core portion 36 positioned on the first axial side of the spacer 38 and the through hole 36a of the rotor core portion 36 positioned on the second axial side of the spacer 38, and the rotor 30 can be cooled in a wide range and uniformly in the axial direction. A plurality of spacer flow path portions 96 are provided in the spacer 38 at intervals from one another in the circumferential direction. In the present example embodiment, the spacer 38 is provided with eight spacer flow path portions 96 at equal pitches in the circumferential direction.

In the present example embodiment, as described above, the orientation of the twist of the step skew of the plurality of first rotor core portions 36A arrayed on the first axial side of the spacer 38 and the orientation of the twist of the step skew of the plurality of second rotor core portions 36B arrayed on the second axial side of the spacer 38 are different from each other. Therefore, there is a case where the oil O flowing inside the through hole 36a from the spacer 38 toward both sides in the axial direction easily stably reach both axial end portions of the rotor body 32 depending on the rotation direction of the rotor 30.

As illustrated in FIG. 4, the spacer flow path portion 96 includes an upstream side flow path portion 96a and a downstream side flow path portion 96b. The upstream side flow path portion 96a is arranged in a radially inner part of the spacer flow path portion 96. The upstream side flow path portion 96a extends in the radial direction. The upstream side flow path portion 96a opposes the refrigerant supply hole 33 from radial outside. The circumferential dimension of the upstream side flow path portion 96a is preferably equal to or greater than the circumferential dimension (inner diameter) of the refrigerant supply hole 33.

The downstream side flow path portion 96b is arranged in a radially outside portion of the spacer flow path portion 96. The downstream side flow path portion 96b is arranged radially outside the upstream side flow path portion 96a and is connected to the upstream side flow path portion 96a. The downstream side flow path portion 96b has a substantially quadrangular shape when viewed from the axial direction, and has a substantially rectangular shape extending in the circumferential direction in the present example embodiment. In short, the circumferential dimension of the downstream side flow path portion 96b is greater than the radial dimension of the downstream side flow path portion 96b. The circumferential dimension of the downstream side flow path portion 96b increases as approaching the radial outside. The radial dimension of the downstream side flow path portion 96b is substantially constant along the circumferential direction. The circumferential dimension of the downstream side flow path portion 96b is greater than the circumferential dimension of the upstream side flow path portion 96a. The radial dimension of the downstream side flow path portion 96b is greater than the radial dimension of the upstream side flow path portion 96a. The downstream side flow path portion 96b axially opposes the through hole 36a. The downstream side flow path portion 96b has the opening area in the cross section perpendicular to the central axis J that is greater than the opening area in the cross section perpendicular to the central axis J of the through hole 36a. According to the present example embodiment, when the oil O flows from the spacer flow path portion 96 into the through hole 36a, a pressure loss can be suppressed to be small in the downstream side flow path portion 96b where the orientation of the flow of the oil O changes.

As illustrated in FIGS. 2 and 3, the end plate 39 has a ring plate shape about the central axis J, and has an annular plate shape in the present example embodiment. A pair of the end plates 39 are provided at the both axial end portions of the rotor body 32. The pair of end plates 39 contact, from the axial direction, the rotor core portion 36 positioned at the end portion on the first axial side and the rotor core portion 36 positioned at the end portion of the second axial side of the plurality of rotor core portions 36. The end plate 39 opposes the rotor core portion 36 from the side opposite to the spacer 38 in the axial direction.

As illustrated in FIG. 3, the end plate 39 includes a guide flow path portion 97 communicating with the through hole 36a. The guide flow path portion 97 includes a circumferential flow path portion 97a, a radial flow path portion 97b, and a communicating flow path portion 97c. The circumferential flow path portion 97a is axially recessed from the surface of the end plate 39 axially opposing the rotor core portion 36, and has a circumferentially extending groove shape. The circumferential flow path portion 97a has an annular shape about the central axis J. The circumferential flow path portion 97a axially opposes the through hole 36a. The circumferential flow path portion 97a communicates with the plurality of through holes 36a arranged in the circumferential direction in the rotor core portion 36 opposing the end plate 39.

The radial flow path portion 97b is axially recessed from the surface of the end plate 39 axially facing the side opposite to the rotor core portion 36, and has a radially extending groove shape. The radial flow path portion 97b is opening on an outer peripheral surface of the end plate 39. That is, the radial flow path portion 97b is opening radially outward. A plurality of the radial flow path portions 97b are provided at intervals from one another in the circumferential direction. The number of the radial flow path portions 97b is the same as the number of the through holes 36a included in the rotor core portion 36 opposing the end plate 39, for example, and is eight in the present example embodiment.

The communicating flow path portion 97c has a hole shape axially penetrating the end plate 39. The communicating flow path portion 97c allows the circumferential flow path portion 97a and the radial flow path portion 97b to communicate with each other. In the present example embodiment, the communicating flow path portion 97c is opening at a radially outer end portion of the circumferential flow path portion 97a and a radially inner end portion of the radial flow path portion 97b. A plurality of the communicating flow path portions 97c are provided at intervals from one another in the circumferential direction. The number of the communicating flow path portions 97c is the same as the number of the radial flow path portions 97b, and is, for example, eight in the present example embodiment.

The guide flow path portion 97 guides, toward a coil 42c described later of the stator 40, the oil O flowing into the guide flow path portion 97 from the through hole 36a (see FIG. 1). According to the present example embodiment, it is possible to further cool the coil 42c by using the oil O after circulating through the through hole 36a and cooling the rotor 30, and the cooling efficiency is improved.

As illustrated in FIG. 1, the stator 40 radially opposes the rotor 30 with a gap interposed therebetween. The stator 40 surrounds the rotor 30 from the radially outside over the entire circumference in the circumferential direction. The stator 40 is fixed inside the motor housing 81. The stator 40 includes a stator core 41 and a coil assembly 42.

The stator core 41 has an annular shape surrounding the central axis J of the rotating electric machine 10. The stator core 41 includes a plurality of plate members such as electromagnetic steel sheets, for example, stacked in the axial direction. The coil assembly 42 includes a plurality of the coils 42c attached to the stator core 41 along the circumferential direction. The plurality of coils 42c are attached to teeth (not illustrated) of the stator core 41 with insulators (not illustrated) interposed therebetween. The plurality of coils 42c are arranged along the circumferential direction. The coil 42c has a part axially protruding from the stator core 41.

The refrigerant flow path 90 is provided in the housing 80. The oil O as a refrigerant flows through the refrigerant flow path 90. The refrigerant flow path 90 is provided across the inside of the motor housing 81 and the inside of the gear housing 82. The refrigerant flow path 90 is a path through which the oil stored in the gear housing 82 is supplied to the rotating electric machine 10 in the motor housing 81 and returns into the gear housing 82 again. The refrigerant flow path 90 is provided with a pump 71 and a cooler 72. The refrigerant flow path 90 includes a first flow path portion 91, a second flow path portion 92, a third flow path portion 93, a stator refrigerant supply portion 50, the shaft flow path portion 95, a connection flow path portion 94, the spacer flow path portion 96, the through hole flow path portion 98, and the guide flow path portion 97.

The first flow path portion 91, the second flow path portion 92, and the third flow path portion 93 are provided in a wall portion of the gear housing 82, for example. The first flow path portion 91 connects the pump 71 and a part where the oil O is stored inside the gear housing 82. The second flow path portion 92 connects the pump 71 and the cooler 72. The third flow path portion 93 connects the cooler 72 and the stator refrigerant supply portion 50. In the present example embodiment, the third flow path portion 93 is connected to an end portion of the left side of the stator refrigerant supply portion 50, i.e., an upstream side portion of the stator refrigerant supply portion 50.

The stator refrigerant supply portion 50 supplies the oil O to the stator 40. In the present example embodiment, the stator refrigerant supply portion 50 has an axially extending tubular shape. In other words, in the present example embodiment, the stator refrigerant supply portion 50 is an axially extending pipe. Both axial end portions of the stator refrigerant supply portion 50 are supported by the motor housing 81. The end portion of the left side of the stator refrigerant supply portion 50 is supported by the partition wall portion 81b, for example. An end portion of the right side of the stator refrigerant supply portion is supported by the lid portion 81c, for example. The stator refrigerant supply portion 50 is positioned radially outside the stator 40. In the present example embodiment, the stator refrigerant supply portion 50 is positioned above the stator 40.

The stator refrigerant supply portion 50 has a supply port 50a for supplying the oil O to the stator 40. In the present example embodiment, the supply port 50a is an injection port for injecting a part of the oil O flowing into the stator refrigerant supply portion 50 to the outside of the stator refrigerant supply portion 50. The supply port 50a includes a hole penetrating a wall portion of the stator refrigerant supply portion 50 from an inner peripheral surface to an outer peripheral surface. A plurality of the supply ports 50a are provided in the stator refrigerant supply portion 50. The plurality of supply ports 50a are arranged at intervals from one another in the axial direction or the circumferential direction, for example.

The shaft flow path portion 95 is arranged in the shaft 31. As illustrated in FIG. 3, the shaft flow path portion 95 includes the inner peripheral surface of the shaft 31, the refrigerant guide portion 31a, and the refrigerant supply hole 33. As illustrated in FIG. 1, the connection flow path portion 94 connects the inside of the stator refrigerant supply portion 50 and the inside of the shaft 31. The connection flow path portion 94 connects the end portion of the right side, i.e., a downstream side portion of the stator refrigerant supply portion 50 and an end portion of the right side, i.e., an upstream side portion of the shaft flow path portion 95. The connection flow path portion 94 is provided in the lid portion 81c, for example. According to the present example embodiment, it is possible to stably cool the stator 40 and the rotor 30 while simplifying the configuration of the refrigerant flow path 90.

The through hole flow path portion 98 connects the spacer flow path portion 96 and the guide flow path portion 97. The through hole flow path portion 98 is arranged over the inside of the plurality of rotor core portions 36. As illustrated in FIGS. 3 and 4, the through hole flow path portion 98 includes the through hole 36a of the rotor core portion 36 and the part 36c of the end surface facing the axial direction.

As illustrated in FIG. 1, when the pump 71 is driven, the oil O stored in the gear housing 82 is sucked up through the first flow path portion 91, and flows into the cooler 72 through the second flow path portion 92. The oil O flowing into the cooler 72 is cooled in the cooler 72, and then flows to the stator refrigerant supply portion 50 through the third flow path portion 93. A part of the oil O flowing into the stator refrigerant supply portion 50 is injected from the supply port 50a and supplied to the stator 40. Another part of the oil O flowing into the stator refrigerant supply portion 50 flows into the shaft flow path portion 95 through the connection flow path portion 94. A part of the oil O flowing through the shaft flow path portion 95 flows from the refrigerant supply hole 33 through the spacer flow path portion 96, the through hole flow path portion 98, and the guide flow path portion 97, and scatters to the stator 40. Another part of the oil O flowing into the shaft flow path portion 95 is discharged from the opening on the left side of the shaft 31 to the inside of the gear housing 82, and stored in the gear housing 82 again.

The oil O supplied from the supply port 50a to the stator 40 takes heat from the stator 40, and the oil O supplied from the shaft 31 to the rotor 30 and the stator 40 takes heat from the rotor 30 and the stator 40. The oil O having cooled the stator 40 and the rotor 30 drops downward to accumulate in a lower region in the motor housing 81. The oil O accumulated in the lower region in the motor housing 81 returns in the gear housing 82 through the partition wall opening 81d provided in the partition wall portion 81b. As described above, the refrigerant flow path 90 supplies the oil O stored in the gear housing 82 to the rotor 30 and the stator 40.

Note that the present disclosure is not limited to the above-described example embodiment, and the configuration can be changed or the like within a range not departing from a spirit of the present disclosure as described below, for example.

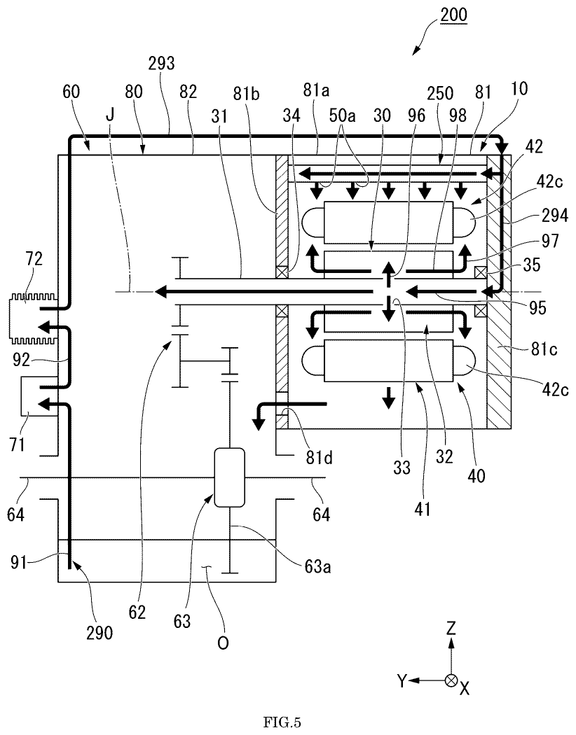

FIG. 5 is a schematic configuration diagram schematically illustrating a drive device 200, which is a modification of the drive device 100. In this modification, a refrigerant flow path 290 includes the first flow path portion 91, the second flow path portion 92, a third flow path portion 293, a stator refrigerant supply portion 250, the shaft flow path portion a supply flow path portion 294, the spacer flow path portion 96, the through hole flow path portion 98, and the guide flow path portion 97. The third flow path portion 293 connects the cooler 72 and the supply flow path portion 294. The third flow path portion 293 is provided across, for example, the gear housing 82 and the motor housing 81. The supply flow path portion 294 is provided in the lid portion 81c, for example. The supply flow path portion 294 branches into a flow path portion connecting the third flow path portion 293 and the stator refrigerant supply portion 250, and a flow path portion connecting the third flow path portion 293 and the shaft flow path portion 95. The branched supply flow path portions 294 are respectively connected to an end portion of the right side, that is, an upstream side portion of the stator refrigerant supply portion 250 and the end portion of the right side, i.e., the upstream side portion of the shaft flow path portion 95. In short, the supply flow path portion 294 supplies the oil O to an upstream side portion of the stator refrigerant supply portion 250 and an upstream side portion of the shaft flow path portion 95. In this modification, the oil O flows from the right side to the left side inside the stator refrigerant supply portion 250. The oil O flowing from the supply flow path portion 294 into the stator refrigerant supply portion 250 is, for example, entirely supplied from the supply port 50a to the stator Also in this modification, it is possible to stably cool the stator 40 and the rotor 30 while simplifying the configuration of the refrigerant flow path 290. Other configurations of the drive device 200 are similar to the other configurations of the drive device 100 described above.

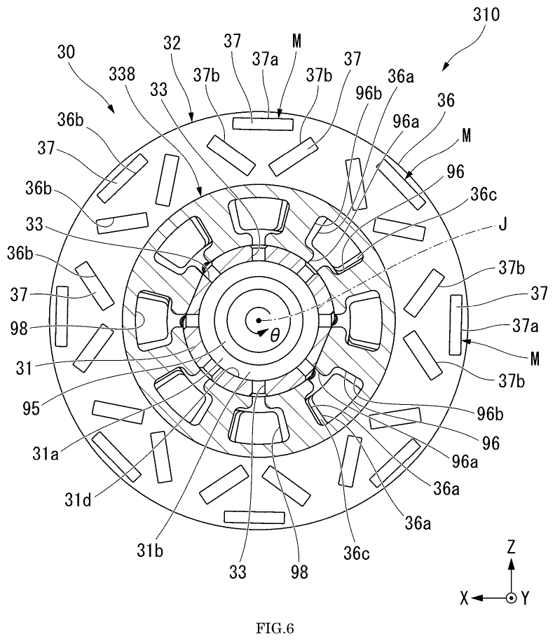

In the above-described example embodiment, an example in which the radially outer end portion of the spacer 38 overlaps the magnet 37 when viewed from the axial direction as illustrated in FIG. 4 has been described, but the present disclosure is not limited to this configuration. As in a rotating electric machine 310 illustrated in FIG. 6, a radially outer end portion of a spacer 338 may be positioned radially inside relative to at least the first magnet 37a arranged at the radially outer end portion of the set M of the three magnets 37, for example. In short, the radially outer end portion of the spacer 338 may be positioned radially inside relative to at least one of the plurality of magnets 37. In this case, it is possible to further suppress an eddy current loss from occurring in the outer peripheral portion of the rotor 30. In FIG. 6, the radially outer end portion of the spacer 338 is positioned radially inside relative to any of the magnets 37 of the set M of the three magnets 37.

The refrigerant flowing through the refrigerant flow path 90 or 290 is not limited to the oil O. For example, the refrigerant may be an insulating liquid or water. In the case where the refrigerant is water, the surface of the stator 40 may be subjected to an insulating treatment.

A rotating electric machine to which the present disclosure is applied is not limited to a motor, and may be a generator. The use of the rotating electric machine is not particularly limited. The rotating electric machine may be mounted on a vehicle for uses other than the use of rotating an axle for example, or may be mounted on equipment other than a vehicle. The attitude of the rotating electric machine when used is not particularly limited.

The configurations described in the above-described example embodiment, modifications, and the like may be combined within the scope not departing from the spirit of the present disclosure, and addition, omission, replacement, and other changes of the configuration are possible. The present disclosure is not limited by the above-described example embodiment, but is limited only by the scope of the claims.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-13. (canceled)

14. A rotating electric machine comprising:
a rotor rotatable about a central axis; and
a stator positioned radially outside the rotor; wherein
the rotor includes:
a shaft axially extending about the central axis;
rotor core portions fixed to an outer peripheral surface of the shaft and extending in an axial direction;
a magnet held by each of the rotor core portions; and
at least one spacer including a non-magnetic body with a ring-plate shape about the central axis and is located between the rotor core portions axially adjacent to each other; and
the spacer is smaller in outer diameter than the rotor core portion.

15. The rotating electric machine according to claim 14, wherein
the shaft has a tubular shape through which a refrigerant can circulate inside of the shaft;
the shaft includes a refrigerant supply hole penetrating a peripheral wall of the shaft;
the rotor core portion includes a through hole axially penetrating the rotor core portion; and
the spacer has a recessed shape recessed radially outward from an inner peripheral surface of the spacer, and includes a spacer flow path portion connecting the refrigerant supply hole and the through hole.

16. The rotating electric machine according to claim 15, wherein the spacer flow path portion axially penetrates the spacer.

17. The rotating electric machine according to claim 15, wherein
the spacer flow path portion includes:
an upstream side flow path portion opposing the refrigerant supply hole from radially outside; and
a downstream side flow path portion radially outside the upstream side flow path portion, connected to the upstream side flow path portion, and axially opposing the through hole; and
the downstream side flow path portion includes an opening area in a cross section perpendicular or substantially perpendicular to the central axis that is greater than the opening area of the through hole.

18. The rotating electric machine according to claim 17, wherein a circumferential dimension of the downstream side flow path portion is greater than a circumferential dimension of the upstream side flow path portion.

19. The rotating electric machine according to claim 17, wherein a radial dimension of the downstream side flow path portion is greater than a radial dimension of the upstream side flow path portion.

20. The rotating electric machine according to claim 15, wherein
the rotor includes an end plate opposing the rotor core portion from a side opposite to the spacer in an axial direction;
the end plate includes a guide flow path portion communicating with the through hole; and
the guide flow path portion guides, toward a coil of the stator, a refrigerant flowing into the guide flow path portion from the through hole.

21. The rotating electric machine according to claim 15, wherein
the shaft includes a refrigerant guide portion recessed radially outward from an inner peripheral surface of the shaft; and
the refrigerant supply hole is defined by an opening in the refrigerant guide portion.

22. The rotating electric machine according to claim 14, wherein at least two or more of the rotor core portions are positioned such that circumferential positions thereof are shifted from each other.

23. The rotating electric machine according to claim 22, wherein
the rotor core portions include:
first rotor core portions on a first axial side relative to the spacer; and
second rotor core portions on a second axial side relative to the spacer;
the first rotor core portions are shifted to a first circumferential direction along with increasing distance from the spacer to a first axial side; and
the second rotor core portions are shifted to the first circumferential direction with increasing distance from the spacer to a second axial side.

24. The rotating electric machine according to claim 14, wherein a radially outer end portion of the spacer is positioned radially inside relative to at least one of a plurality of the magnets.

25. A drive device that is mounted in a vehicle and rotates an axle, the drive device comprising:
the rotating electric machine according to claim 14;
a transmission connected to the rotating electric machine and transmits rotation of the rotor to the axle;
a housing that accommodates the rotating electric machine and the transmission device; and
a refrigerant flow path that is provided in the housing, the refrigerant flow path permitting a refrigerant to flow therethrough; wherein
the refrigerant flow path includes:
a stator refrigerant supply to supply a refrigerant to the stator;
a shaft flow path portion in the shaft; and
a connection flow path portion that connects a downstream side portion of the stator refrigerant supply portion and an upstream side portion of the shaft flow path portion.

26. A drive device that is mounted in a vehicle and rotates an axle, the drive device comprising:
the rotating electric machine according to claim 14;
a transmission that is connected to the rotating electric machine to transmit rotation of the rotor to the axle;
a housing that accommodates the rotating electric machine and the transmission device; and
a refrigerant flow path that is provided in the housing, the refrigerant flow path permitting a refrigerant to flow therethrough; wherein
the refrigerant flow path includes:
a stator refrigerant supply portion to supply a refrigerant to the stator;
a shaft flow path portion in the shaft; and
a supply flow path portion to supply a refrigerant to an upstream side portion of the stator refrigerant supply portion and an upstream side portion of the shaft flow path portion.
